(19) United States
(12) Patent Application Publication
(10) Pub. No.: US 2023/0274875 A1
(43) Pub. Date: Aug. 31, 2023

(54) COIL COMPONENT

(71) Applicant: Murata Manufacturing Co., Ltd., Kyoto-fu (JP)

(72) Inventor: Katsuyuki TAKAHASHI, Nagaokakyo-shi (JP)

(73) Assignee: Murata Manufacturing Co., Ltd., Kyoto-fu (JP)

(21) Appl. No.: 18/172,901

(22) Filed: Feb. 22, 2023

(30) Foreign Application Priority Data
Feb. 28, 2022 (JP) 2022-029446

(51) Int. Cl. H01F 27/29; H01F 27/24

(52) U.S. Cl. CPC H01F 27/292; H01F 27/24

(57) ABSTRACT

A coil component includes a core. The core includes a winding core portion extending in an axial direction, and first and second flange portions respectively at end portions of the winding core portion opposite to each other in the axial direction. Each of the first and second flange portions includes raised portion raised at a central portion in a direction orthogonal to the axial direction and shoulder portions lower than the raised portion on both sides of the raised portion. A recess is on an inner end surface on which the end portion of the winding core portion in the axial direction in each of the first and second flange portion is positioned, and at least an end portion of the winding core portion in the axial direction is in the recess, is on the raised portion side, and bites into the inner end surface.

### CROSS-REFERENCE TO RELATED APPLICATION

This application claims benefit of priority to Japanese Patent Application No. 2022-029446, filed Feb. 28, 2022, the entire content of which is incorporated herein by reference.

### BACKGROUND

### Technical Field

The present disclosure relates to a winding-type coil component having a structure in which a wire is wound around a core, and particularly relates to a structure of a connection portion of a flange portion and a winding core portion provided in the core.

### Background Art

For example, Japanese Patent Application Laid-Open No. 2021-39961 describes a core provided with a raised portion raised at a central portion of an upper surface of a flange portion in a width direction. FIG. 12B schematically illustrates a core 51 described in Japanese Patent Application Laid-Open No. 2021-39961.

Referring to FIG. 12B, the core 51 includes a winding core portion 52 extending in an axial direction AX and a first flange portion 53 and a second flange portion 54 provided at end portions of the winding core portion 52 opposite to each other in the axial direction AX.

The first flange portion 53 and the second flange portion 54 have mounting surfaces 55 and 56 facing a mounting board side during mounting, top surfaces 57 and 58 facing opposite sides of the mounting surfaces 55 and 56, inner end surfaces 59 and 60 on which the end portions of the winding core portion 52 in the axial direction AX are positioned, outer end surfaces 61 and 62 facing opposite sides of the inner end surfaces 59 and 60, the inner and outer end surfaces connecting the mounting surfaces 55 and 56 and the top surfaces 57 and 58, and first side surfaces 63 and 64 and second side surfaces 65 and 66 that connect the inner end surfaces 59 and 60 and the outer end surfaces 61 and 62 and face in opposite directions to each other, respectively.

In Japanese Patent Application Laid-Open No. 2021-39961, raised portions 67 raised at central portions of the top surfaces 57 and 58 in a direction orthogonal to the axial direction AX, and shoulder portions 68 lower than the raised portion 67 are formed on both sides of the raised portion 67. More specifically, when a direction in which the first side surfaces 63 and 64 and the second side surfaces 65 and 66 of the flange portions 53 and 54 face is a width direction WD, the raised portions 67 raised at the central portions of the top surfaces 57 and 58 in the width direction WD are provided, and the shoulder portions 68 lower than the raised portion 67 are formed on both sides of the raised portion 67 in the width direction WD.

The core 51 is obtained by compression-molding powder such as ferrite by using a pair of a punch and a die and firing the obtained molded body. If necessary, barrel polishing may be performed to remove burrs after firing.

### SUMMARY

FIG. 12A illustrates a punch 69 used for molding the core 51 illustrated in FIG. 12B. In FIG. 12A, the punch 69 is illustrated with a working surface facing upward. Accordingly, the punch 69 achieves molding by descending from above the die (not illustrated.) filled with molding powder toward the die in a state of being turned upside down from the illustrated posture.

As illustrated in FIG. 12A, in the punch 69, a portion (a raised portion corresponding portion) 67a corresponding to the raised portion 67 of the core 51 to be molded, a portion (a shoulder portion corresponding portion) 68a corresponding to the shoulder portion 68, and a portion (a winding core portion corresponding portion) 52a corresponding to the winding core portion 52 are provided at predetermined height positions. Here, when attention is paid to a connection portion between the raised portion corresponding portion 67a and the shoulder portion corresponding portion 68a of the punch 69 and the winding core portion corresponding portion 52a, it can be seen that a thin portion 70 is present therein. It can be said that the thin portion 70 is formed as a result of trying to mold the raised portion 67.

The thin portion 70 merely forms a line contact portion, is extremely thin, and may form a minute gap. Thus, a section of the connection portion between the raised portion corresponding portion 67a, the shoulder portion corresponding portion 68a, and the winding core portion corresponding portion 52a is extremely small, and mechanical strength is extremely low. Accordingly, the punch 69 is easily deformed by a pressure during molding of the core 51, and the thin portion 70 may be broken.

Therefore, the present disclosure provides a coil component including a core that does not need to provide a flange portion in a molding punch while including a raised portion in the flange portion.

The present disclosure provides a coil component including a core that has a winding core portion extending in an axial direction and a first flange portion and a second flange portion provided at end portions of the winding core portion opposite to each other in the axial direction, a first terminal electrode that is provided at the first flange portion, a second terminal electrode that is provided at the second flange portion, and at least one wire that is connected to the first terminal electrode and the second terminal electrode, and is wounded around the winding core portion.

A raised portion raised at a central portion in a direction orthogonal to the axial direction is provided and shoulder portions lower than the raised portion are formed on both sides of the raised portion in the direction orthogonal to the axial direction on any surface around each of the first flange portion and the second flange portion.

In the present disclosure, in order to solve the above-described technical problem, a recess is provided on an inner end surface on which the end portion of the winding core portion in the axial direction in each of the first flange portion and the second flange portion is positioned, and at least a portion which is the end portion of the winding core portion in the axial direction is positioned in the recess, the portion being on the raised portion side, and bites into the inner end surface.

According to the present disclosure, though the flange portion includes the raised portion, since the core in a state in which the end portion of the winding core portion in the axial direction bites into the inner end surface is provided, in the punch for molding the core, it is possible to provide sufficient overlap between the raised portion corresponding portion, the shoulder portion corresponding portion, and the winding core portion corresponding portion, and it is possible to relatively increase the section of the connection portion between these portions. Accordingly, the mechanical strength of the punch can be increased, and the punch can be less likely to be deformed by the pressure during molding of the core.

### BRIEF DESCRIPTION OF THE DRAWINGS

FIG. 1 is a perspective view illustrating an appearance of a coil component according to a first embodiment of the present disclosure with mounting surfaces facing upward;

FIG. 2 is a bottom view illustrating the appearance of the coil component illustrated in FIG. 1 from the mounting surfaces;

FIG. 3 is a front view illustrating the appearance of the coil component illustrated in FIG. 1 with the mounting surfaces facing upward;

FIG. 4 is a sectional view of the coil component taken along line A-A in FIG. 2;

FIG. 5 is a perspective view illustrating an appearance of a core provided in the coil component 1 illustrated in FIG. 1 with the mounting surfaces facing upward;

FIG. 6 is a bottom view illustrating the appearance of the core illustrated in FIG. 5 from the mounting surfaces;

FIG. 7 is a sectional view of the core taken along line B-B in FIG. 6;

FIG. 8 is a perspective view illustrating an appearance of a core provided in a coil component according to a second embodiment of the present disclosure with the mounting surfaces facing upward;

FIGS. 9A and 9B schematically illustrate a molding step of the core illustrated in FIG. 5 or the core illustrated in FIG. 8, FIG. 9A is a perspective view illustrating a punch, and FIG. 9B is a perspective view illustrating a core molded by the punch illustrated in FIG. 9A;

FIGS. 10A and 10B are diagrams corresponding to FIGS. 9A and 9B illustrating a first modification of the molding step of the core;

FIGS. 11A and 11B are diagrams corresponding to FIGS. 9A and 9B illustrating a second modification of the molding step of the core; and

FIGS. 12A and 12B are diagrams corresponding to FIGS. 9A and 9B illustrating a molding step of the core described in Japanese Patent Application Laid-Open No. 2021-39961.

### DETAILED DESCRIPTION

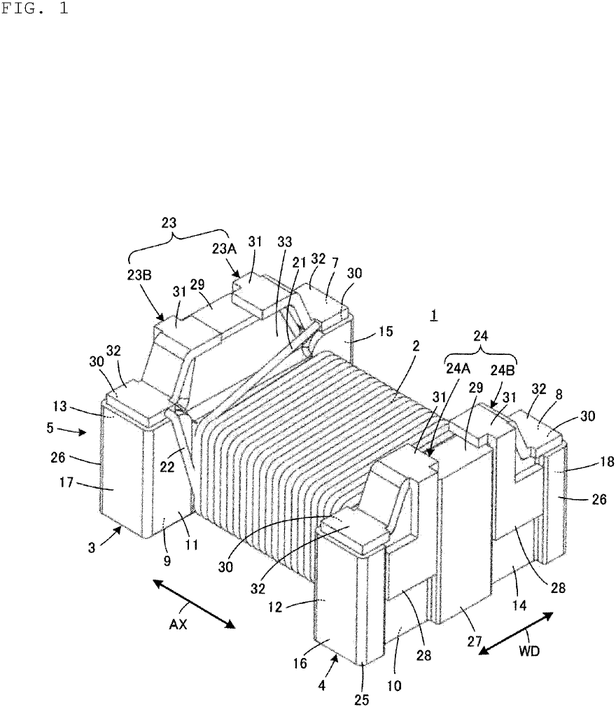

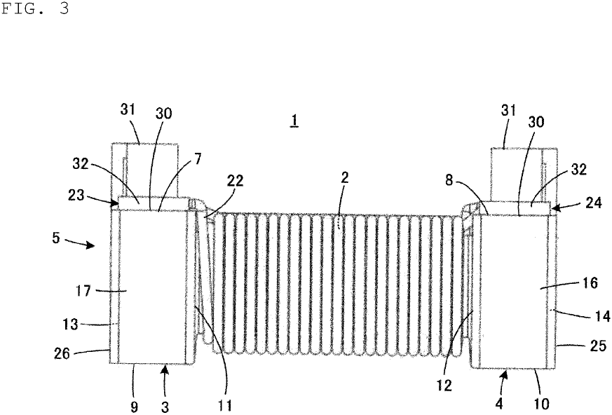

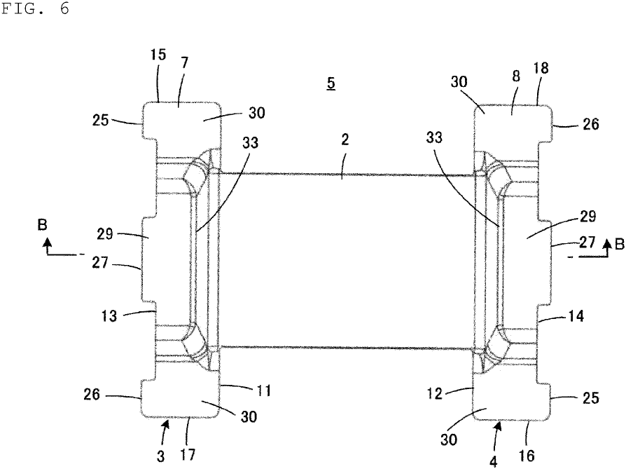

A coil component 1 according to a first embodiment of the present disclosure will be described with reference to FIGS. 1 to 7.

The coil component 1 includes a drum-shaped core 5 having a winding core portion 2 extending in an axial direction AX and a first flange portion 3 and a second flange portion 4 provided at end portions of the winding core portion 2 opposite to each other in the axial direction AX. The core 5 is made of, for example, ferrite, a resin containing ferrite powder or metal magnetic powder, or a nonmagnetic material such as alumina. The winding core portion 2 has a substantially quadrangular sectional shape in the drawing, but may have a polygonal shape such as a hexagonal shape, a circular shape, an elliptical shape, or a shape obtained by combining these shapes.

The first flange portion 3 includes a mounting surface 7 facing a mounting board side during mounting, a top surface 9 facing an opposite side of the mounting surface 7, an inner end surface 11 that faces the winding core portion 2 side and positions the end portion of the winding core portion 2 in the axial direction AX, an outer end surface 13 that faces an opposite side of the inner end surface 11, the inner and outer end surfaces connecting the mounting surface 7 and the top surface 9, a first side surface 15 and a second side surface 17 that connect the inner end surface 11 and the outer end surface 13 and face in opposite directions to each other.

Similarly, the second flange portion 4 has a mounting surface 8 facing a mounting board side during mounting, a top surface 10 facing an opposite side of the mounting surface 8, an inner end surface 12 that faces the winding core portion 2 side and positions the end portion of the winding core portion 2 in the axial direction AX, an outer end surface 14 that faces an opposite side of the inner end surface 12, the inner and outer end surfaces connecting the mounting surface 8 and the top surface 10, and a first side surface 16 and a second side surface 18 that connect the inner end surface 12 and the outer end surface 14 and face in opposite directions to each other.

As an example, the core 5 has a dimension of 3.5 mm in the axial direction AX, a dimension of 2.6 mm in a width direction WD in which the first side surfaces 15 and 16 and the second side surfaces 17 and 18 face each other, and a dimension of 1.4 mm in a height direction HD in which the mounting surfaces 7 and 8 and the top surfaces 9 and 10 face each other.

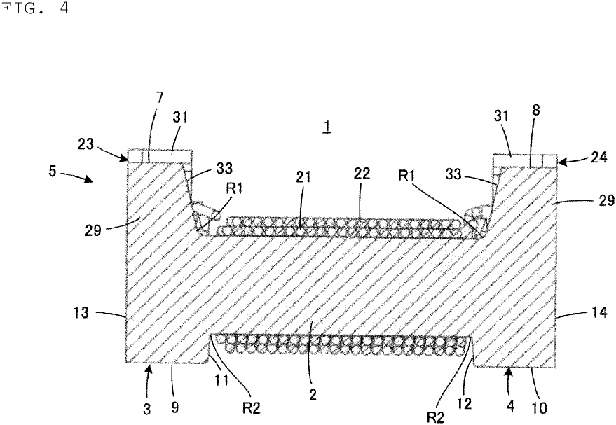

The coil component 1 constitutes, for example, a common mode choke coil, and includes a first wire 21 and a second wire 22 wound around the winding core portion 2 of the core 5. In the common mode choke coil, as is well known, the first wire 21 and the second wire 22 are wound in the same direction around the winding core portion 2. In this embodiment, as well illustrated in FIG. 4, the first wire 21 is wound around the winding core portion 2 to come into contact with the winding core portion 2, and the second wire 22 is wound to come into contact with an outer periphery of the first wire 21. Each of the wires 21 and 22 includes, for example, a center wire material made of a favorable conductive metal such as copper, silver, or gold, and an insulating film covering the center wire material and made of an electrically insulating resin such as polyamideimide, polyurethane, or polyesterimide. It is preferable that wires having a diameter of 20 µm or more and 100 µm or less (i.e., from 20 µm to 100 µm) are used as the wires 22 and 21.

First terminal electrodes 23 are provided at the first flange portion 3, and second terminal electrodes 24 are provided at the second flange portion 4. Two first terminal electrodes 23 spaced apart from each other and aligned in the width direction WD are provided at the first flange portion 3, and two second terminal electrodes 24 spaced apart from each other and aligned in the width direction WD are provided at the second flange portion 4.

In order to distinguish two first terminal electrodes 23 from each other, one first terminal electrode is denoted by reference symbol “23A”, the other first terminal electrode is denoted by reference symbol “23B”, and in a case where two second terminal electrodes 24 are to be distinguished from each other, one second terminal electrode is denoted by reference symbol “24A”, and the other second terminal electrode is denoted by reference symbol “24B”.

A first end portion and a second end portion of the first wire 21 are connected to the first terminal electrode 23A and the second terminal electrode 24B by thermal pressure bonding. A first end portion and the second end portion of the second wire 22 are connected to the first terminal electrode 23B and the second terminal electrode 24A by thermal pressure bonding.

A first ridge 25 extending along a ridgeline where the outer end surface 13 intersects the first side surface 15 and a second ridge 26 extending along a ridgeline where the outer end surface 13 intersects the second side surface 17 are provided on the outer end surface 13 of the first flange portion 3.

A third ridge 27 is provided between the first ridge 25 and the second ridge 26 on the outer end surface 13 of the first flange portion 3.

Similarly, a first ridge 25 extending along a ridgeline where the outer end surface 14 intersects the first side surface 16 and a second ridge 26 extending along a ridgeline where the outer end surface 14 intersects the second side surface 18 on the outer end surface 14 of the second flange portion 4, and a third ridge 27 is provided between the first ridge 25 and the second ridge 26.

As an example, the first ridge 25 and the second ridge 26 have a dimension of 0.2 mm in the width direction and a protrusion height of 0.1 mm. As an example, the third ridge 43 has a dimension of 0.4 mm in the width direction and a protrusion height of 0.1 mm.

It is preferable that the first terminal electrode 23 and the second terminal electrode 24 described above are formed by using a metal plate having a thickness equal to or less than the protrusion height of the first ridge 25 and the second ridge 26. For example, a metal plate in which an element body is made of copper and a surface facing an outside is plated with nickel and tin in this order is used as the metal plate constituting the terminal electrodes 23 and 24. The first terminal electrode 23 has a fixing portion 28 disposed along a region of the outer end surface 13 of the first flange portion 3 where none of the first ridge 25, the second ridge 26, and the third ridge 27 are provided and fixed to the first flange portion 3 with an adhesive interposed therebetween. Similarly, the second terminal electrode 24 has a fixing portion 28 disposed along a region of the outer end surface 14 of the second flange portion 4 where none of the first ridge 25, the second ridge 26, and the third ridge 27 are provided and fixed to the second flange portion 4 with the adhesive interposed therebetween.

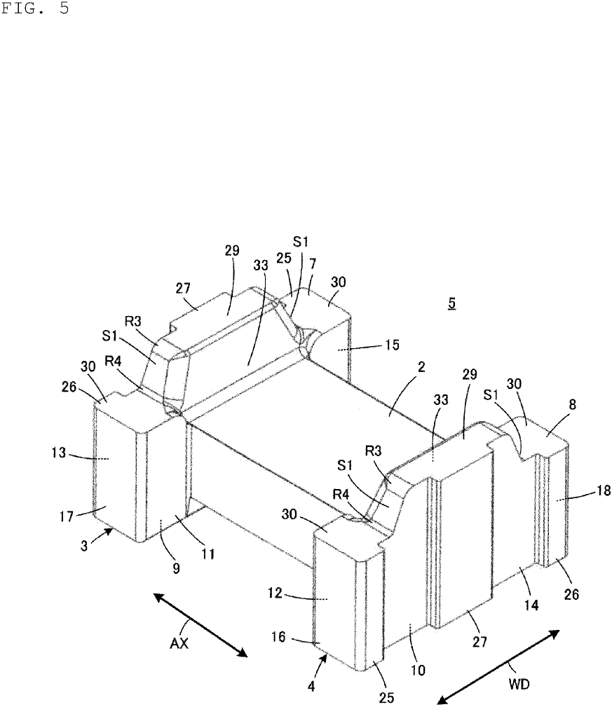

As well illustrated in FIGS. 1 and 5 and the like, raised portions 29 raised at central portions in the width direction WD are provided on the mounting surfaces 7 and 8 of the first flange portion 3 and the second flange portion 4, and shoulder portions 30 lower than the raised portion 29 are formed on both sides of the raised portion 29 in the width direction. Surfaces on which the raised portions are provided are the top surfaces 57 and 58 in Japanese Patent Application Laid-Open No. 2021-39961, but are the mounting surfaces 7 and 8 in this embodiment, and are different from the case of Japanese Patent Application Laid-Open No. 2021-39961 in this respect.

The first terminal electrode 23 and the second terminal electrode 24 have portions curved and extending in an S-shape along the raised portions 29 and the shoulder portions 30 on the mounting surfaces 7 and 8 of the first flange portion 3 and the second flange portion 4.

In the first terminal electrode 23 and the second terminal electrode 24, connection portions with a mounting board (not illustrated.) are provided by portions 31 extending along the raised portions 29, and connection portions with the wires 21 and 22 are provided by portions 32 extending along the shoulder portions 30.

Recesses 33 are provided in the inner end surfaces 11 and 12 of the first flange portion 3 and the second flange portion 4, respectively. At least portions which are the end portions of the winding core portion 2 in the axial direction AX and are on the raised portion 29 side are positioned in the recesses 33 and bite into the inner end surfaces 11 and 12.

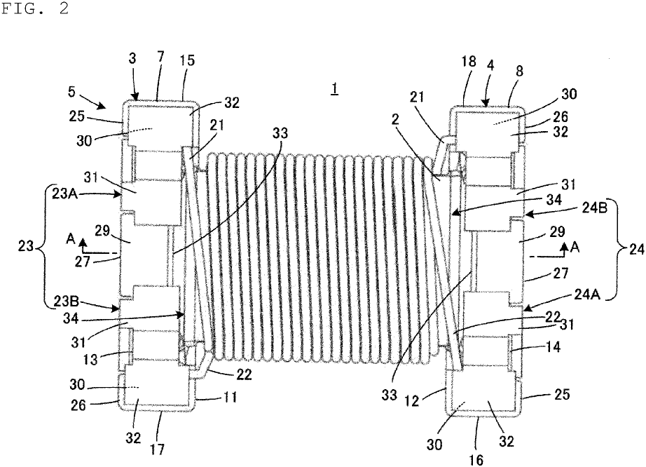

In such a configuration, as described above, when the connection portions with the wires 21 and 22 are provided by the portions 32 extending along the shoulder portions 30, as well illustrated in FIG. 2, gaps 34 are formed between lead-out portions of the wires 21 and 22 drawn from the winding core portion 2 to the first terminal electrode 23 and the second terminal electrode 24 and the inner end surfaces 11 and 12 of the flange portions 3 and 4. The gaps 34 can prevent a flux contained in a solder paste for connection to a mounting board from wetting and spreading on the lead-out portions of the wires 21 and 22, and can reduce a cause of deterioration in quality of the wires 21 and 22 and the coil component 1.

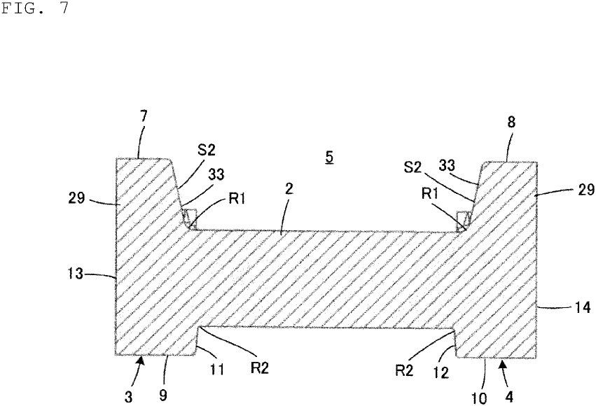

As well illustrated in FIGS. 4 and 7, rounded surfaces are formed at intersections of the winding core portion 2 and the inner end surfaces 11 and 12 of the flange portions 3 and 4. Here, it is preferable that radii of curvature defining rounded surfaces R1 on the mounting surfaces 7 and 8 side are larger than radii of curvature defining rounded surfaces R2 on the top surfaces 9 and 10 side. As a result, the radii of curvature on the rounded surfaces R1 can be increased without reducing the number of linear portions around which the wires 21 and 22 can be wound in the winding core portion 2. After the coil component 1 is mounted, a difference in thermal expansion between the core 5 and the mounting board may occur due to a temperature change, and a force for opening the raised portions 29 of the flange portions 3 and 4 to the outside may be applied. In such a case, there is a concern that stress concentrates on connection portions between the winding core portion 2 and the flange portions 3 and 4. As in the present embodiment, stress concentration can be alleviated by increasing the radius of curvature, and the strength of the core 5 can be increased.

As well illustrated in FIG. 5, it is preferable that rounded surfaces R3 having a radius of curvature of, for example, 0.1 mm or more are formed at both end portions of a top face of the raised portion 29 in the width direction WD. According to this configuration, not only good releasability can be obtained during molding of the core 5, but also when the terminal electrodes 23 and 24 are attached to the core 5, it is easy to bring the metal plates constituting the terminal electrodes 23 and 24 into close contact with the raised portions 29, and it is easy to position the terminal electrodes 23 and 24 with respect to the core 5.

As well illustrated in FIG. 5, it is preferable that rounded surfaces R4 are formed at portions where the raised portions 29 intersect the shoulder portions 30. With this configuration, when the terminal electrodes 23 and 24 are attached to the core 5, it is easy to bring the metal plates constituting the terminal electrodes 23 and 24 into close contact with the raised portion 29, and it is easy to position the terminal electrodes 23 and 24 with respect to the core 5.

As well illustrated in FIG. 5, it is preferable that gradients S1 are given to both end faces of the raised portion 29 in the width direction WD. With this configuration, when the terminal electrodes 23 and 24 are attached to the core 5, it is easy to bring the metal plates constituting the terminal electrodes 23 and 24 into close contact with the raised portion 29, and it is easy to position the terminal electrodes 23 and 24 with respect to the core 5. Good releasability can be obtained during molding of the core 5, and cracks in the core 5 can be less likely to occur.

As well illustrated in FIG. 7, it is preferable that gradients S2 are given to surfaces of the raised portions 29 on the inner end surfaces 11 and 12 side. According to this configuration, good releasability can be obtained during molding of the core 5, and cracks in the core 5 can be less likely to occur.

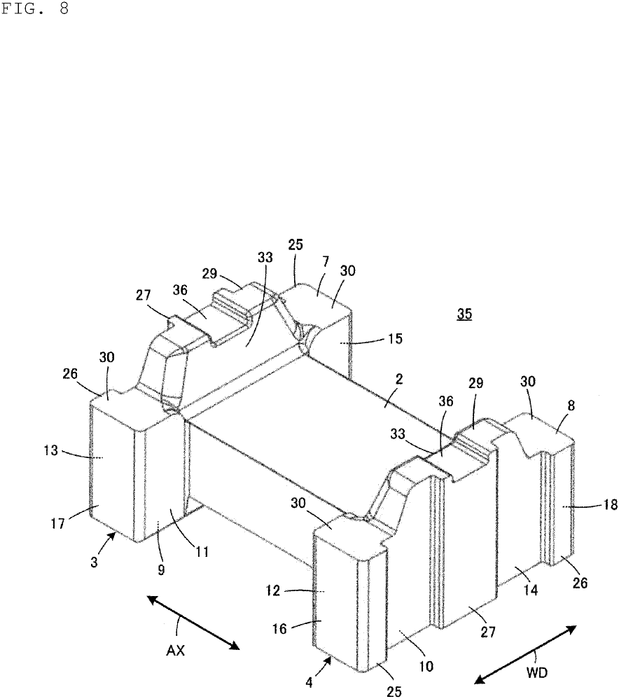

FIG. 8 is a perspective view illustrating an appearance of a core 35 provided in a coil component according to a second embodiment of the present disclosure with the mounting surfaces 7 and 8 facing upward. FIG. 8 corresponds to FIG. 5. In FIG. 8, elements corresponding to the elements illustrated in FIG. 5 are denoted by the same reference symbols, and redundant description is omitted.

The core 35 according to the second embodiment is different from the core 5 according to the first embodiment in that a groove 36 is provided on the top face of the raised portion 29 and the top face of the raised portion 29 is divided into two surfaces in the width direction WD.

According to this configuration, as illustrated in FIGS. 1 and 2, when two first terminal electrodes 23A and 23B are provided in the first flange portion 3 to be spaced apart from each other and aligned in the width direction WD and two second terminal electrodes 24A and 24B are provided in the second flange portion 4 to be spaced apart from each other and aligned in the width direction WD, a creepage distance between two first terminal electrodes 23A and 23B and a creepage distance between two second terminal electrodes 24A and 24B can be longer, and the reliability of electrical insulation can be enhanced. Since a flux contained in a reflow solder in a mounting step can be stored in the groove 36, the wetting and spreading of the flux can be prevented.

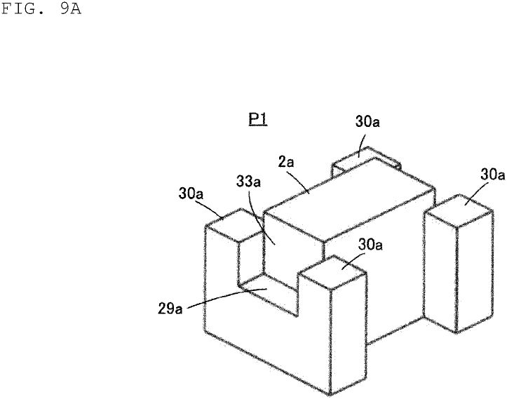

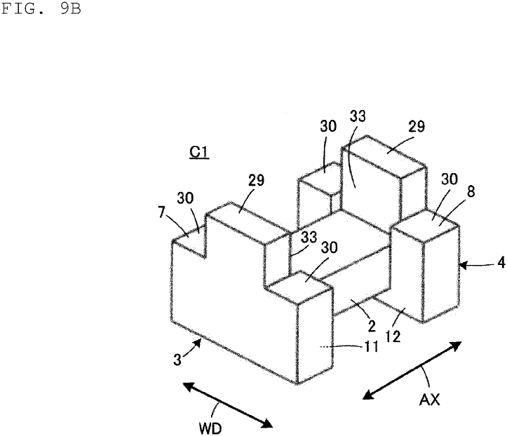

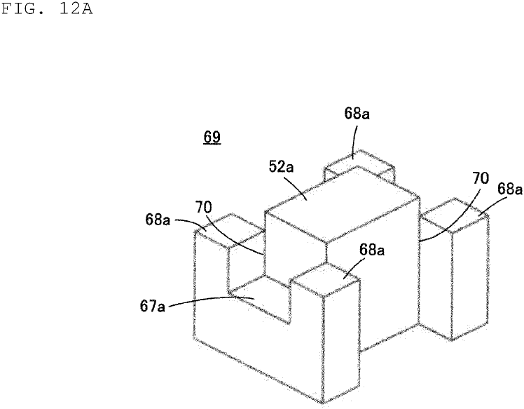

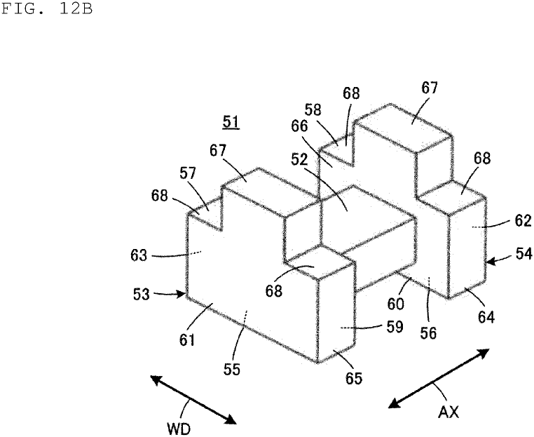

Hereinafter, a punch used in a molding step for cores of various forms and a core obtained by the punch will be described with reference to FIGS. 9A to 12B. As in the case of FIGS. 12A and 12B described above, in FIGS. 9A to 12B, FIG. 9A illustrates a punch, FIG. 9B illustrates a core as a molded body obtained by the punch illustrated in FIG. 9A, and FIG. 9A illustrates the punch with a working surface facing upward.

A core C1 illustrated in FIG. 9B has the same basic structure as the core 5 illustrated in FIG. 5 and the core 35 illustrated in FIG. 8. That is, the raised portion 29 raised at the central portion in the width direction WD is provided on each of the mounting surfaces 7 and 8 of the first flange portion 3 and the second flange portion 4, and the shoulder portions 30 lower than the raised portion 29 are formed on both sides of the raised portion 29 in the width direction WD. The recesses 33 are provided on the inner end surfaces 11 and 12 on the end portions of the winding core portion 2 in the axial direction AX in the first flange portion 3 and the second flange portion 4 are positioned, and the end portions of the winding core portion 2 in the axial direction AX are positioned in the recesses 33 and bit into the inner end surfaces 11 and 12.

On the other hand, a punch P1 illustrated in FIG. 9A includes recess corresponding portions 33a in addition to raised portion corresponding portions 29a, shoulder portion corresponding portions 30a, and winding core portion corresponding portions 2a. Here, as compared with the punch 69 illustrated in FIG. 12A, in the punch 69 illustrated in FIG. 12A, the extremely thin portions 70 are present at the connection portion between the raised portion corresponding portions 67a and the shoulder portion corresponding portions 68a and the winding core portion corresponding portion 52a. Meanwhile, in the punch P1 illustrated in FIG. 9A, since the recess corresponding portion 33a cuts into the connection portion between the raised portion corresponding portion 29a, the shoulder portion corresponding portions 30a, and the winding core portion corresponding portion 2a, sufficient overlap can be provided between the raised portion corresponding portion 29a and the shoulder portion corresponding portions 30a, and the winding core portion corresponding portion 2a. Accordingly, the mechanical strength of the punch P1 can be increased.

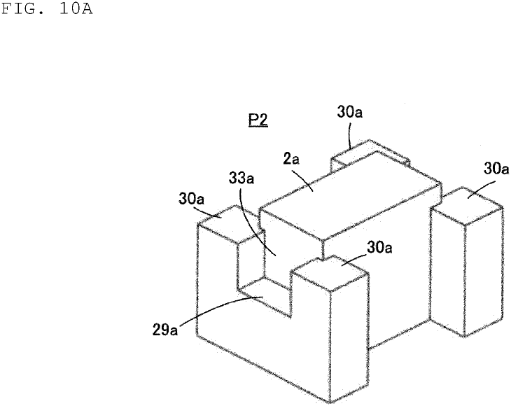

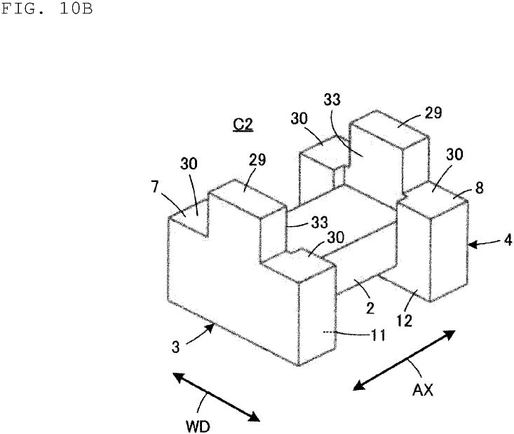

Next, in a core C2 illustrated in FIG. 10B, a dimension of the raised portion 29 in the width direction WD is smaller than the dimension of the core C1 illustrated in FIG. 9B. In the core C1 illustrated in FIG. 9B, the dimension of the raised portion 29 in the width direction WD is the same as the dimension of the winding core portion 2 in the width direction WD. However, in the core C2 illustrated in FIG. 10B, the dimension of the raised portion 29 in the width direction WD is smaller than the dimension of the winding core portion 2 in the width direction WD.

On the other hand, a punch P2 illustrated in FIG. 10A has raised portion corresponding portions 29a, shoulder portion corresponding portions 30a, winding core portion corresponding portions 2a, and recess corresponding portions 33a. Since the recess corresponding portion 33a cuts into the connection portion between the raised portion corresponding portion 29a, the shoulder portion corresponding portion 30a, and the winding core portion corresponding portion 2a, sufficient overlap can be provided between the raised portion corresponding portion 29a, the shoulder portion corresponding portion 30a, and the winding core portion corresponding portion 2a. Accordingly, the mechanical strength of the punch P2 can be increased, and the punch P2 can be less likely to be deformed by a pressure during molding of the core C2.

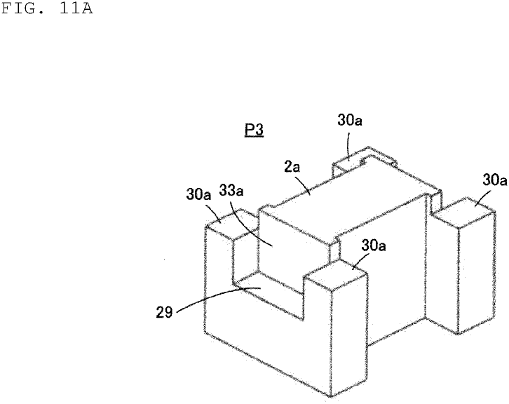

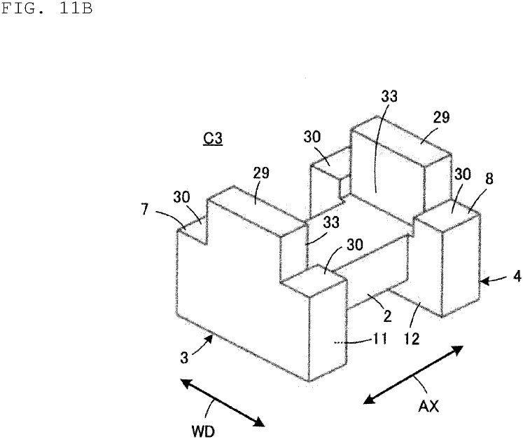

Next, in a core C3 illustrated in FIG. 11B, a dimension of the raised portion 29 in the width direction WD is larger than the dimension of the core C1 illustrated in FIG. 9B. In the core C1 illustrated in FIG. 9B, the dimension of the raised portion 29 in the width direction WD is the same as the dimension of the winding core portion 2 in the width direction WD. However, in the core C3 illustrated in FIG. 11B, the dimension of the raised portion 29 in the width direction WD is larger than the dimension of the winding core portion 2 in the width direction WD.

On the other hand, a punch P3 illustrated in FIG. 11A includes raised portion corresponding portions 29a, shoulder portion corresponding portions 30a, winding core portion corresponding portions 2a, and recess corresponding portions 33a. Since the recess corresponding portion 33a cuts into the connection portion between the raised portion corresponding portion 29a, the shoulder portion corresponding portion 30a, and the winding core portion corresponding portion 2a, sufficient overlap can be provided between the raised portion corresponding portion 29a, the shoulder portion corresponding portion 30a, and the winding core portion corresponding portion 2a. Accordingly, the mechanical strength of the punch P3 can be increased, and the punch P3 can be less likely to be deformed by pressure during molding of the core C3.

Although the present disclosure has been described in conjunction with the illustrated embodiments, various other embodiments are possible within the scope of the present disclosure.

For example, in the illustrated embodiment, although the raised portions 29 are provided on the mounting surfaces 7 and 8 of the flange portions 3 and 4, the raised portions are shaped by a punch operating towards a die. Accordingly, in the case of a molding method of pressing to sandwich the mounting surfaces 7 and 8 and the top surfaces 9 and 10 of the flange portions 3 and 4, the raised portions may be provided on the mounting surfaces 7 and 8 or may be provided on the top surfaces 9 and 10. In the case of the molding method of pressing to sandwich the first side surfaces 15 and 16 and the second side surfaces 17 and 18, the raised portions may be provided on one of the first side surfaces 15 and 16 and one of the second side surfaces 17 and 18.

Accordingly, the raised portions may be provided on any surface around the flange portions, and the shoulder portions lower than the raised portion may be formed on both sides of the raised portion in a direction orthogonal to the axial direction. The recess provided on the inner end surface of the flange portion may receive at least a portion on the raised portion side which is the end portion in the axial direction of the winding core portion, and thus, the winding core portion may be in a state of biting into the inner end surface.

A top plate may be provided to connect the top surface 9 of the first flange portion 3 and the top surface 10 of the second flange portion 4 of the core 5. The top plate is bonded to the core 5 with an adhesive. For example, a thermosetting epoxy resin is used as the adhesive. An inorganic filler such as a silica filler may be added to the adhesive in order to improve thermal shock resistance of the adhesive. Ferrite, a non-conductive material other than ferrite, ferrite powder, a resin containing metal magnetic powder, or the like is used as a material of the top plate. When both the core 5 and the top plate are made of a magnetic material, the core 5 and the top plate constitute a closed magnetic circuit. Coating with resin may be applied instead of the top plate.

The terminal electrodes 23 and 24 may be constituted by conductor films formed on the flange portions 3 and 4 instead of the metal plate. In this case, for example, base electrodes are formed on the mounting surfaces 7 and 8 of the flange portions 3 and 4 by baking a silver paste, base electrodes are formed on the outer end surfaces 13 and 14 of the flange portions 3 and 4 by vapor deposition of silver, and copper, nickel, and tin are plated on the base electrodes in this order.

The coil component to which the present disclosure is directed may constitute a single coil or may constitute a transformer, a balun, or the like other than a common mode choke coil as in the illustrated embodiments. Accordingly, the number of wires is also changed according to a function of the coil component, and the number of terminal electrodes provided on each flange portion can also be changed accordingly.

In configuring the coil component according to the present disclosure, partial replacement or combination of configurations is possible between different embodiments described in this specification.

What is claimed is:

1. A coil component comprising:
a core that has a winding core portion extending in an axial direction and a first flange portion and a second flange portion respectively at first and second end portions of the winding core portion opposite to each other in the axial direction;
a first terminal electrode that is at the first flange portion;
a second terminal electrode that is at the second flange portion; and
at least one wire that is connected to the first terminal electrode and the second terminal electrode and is wound around the winding core portion, wherein
each of the first flange portion and the second flange portion includes a raised portion raised at a central portion in a direction orthogonal to the axial direction and shoulder portions lower than the raised portion on both sides of the raised portion in the direction orthogonal to the axial direction on any surface around each of the first flange portion and the second flange portion,
an inner end surface of each of the first flange portion and the second flange portion, on which a respective one of the first and second end portions of the winding core portion in the axial direction is located, includes a recess, and
a portion of the first end portion of the winding core portion is in the recess of the first flange portion and extends into the inner end surface of the first flange portion, and a portion of the second end portion of the winding core portion is in the recess of the second flange portion and extends into the inner end surface of the second flange portion.

2. The coil component according to claim 1, wherein
each of the first flange portion and the second flange portion includes
a mounting surface facing a mounting board side at a time of mounting,
a top surface facing opposite to the mounting surface,
an outer end surface facing opposite to the inner end surface, the inner and outer end surfaces connecting the mounting surface and the top surface, and
a first side surface and a second side surface that connect the inner end surface and the outer end surface and face in opposite directions to each other, and
when a direction in which the first side surface and the second side surface face is a width direction, the raised portion is in a central portion in the width direction on the mounting surface of each of the first flange portion and the second flange portion, and the shoulder portions are on both sides of the raised portion in the width direction.

3. The coil component according to claim 2, wherein
at each of the first flange portion and the second flange portion,
first and second rounded surfaces are at intersection portions of the winding core portion and the inner end surface, and a radius of curvature defining the first rounded surface at the mounting surface side is larger than a radius of curvature defining the second rounded surface at the top surface side.

4. The coil component according to claim 2, wherein
at the first flange portion, a gap is between the inner end surface and a first lead-out portion of the wire, the first lead-out portion of the wire being drawn from the winding core portion and reaching the first terminal electrode, and
at the second flange portion, a gap is between the inner end surface and a second lead-out portion of the wire, the second lead-out portion of the wire being drawn from the winding core portion and reaching the second terminal electrode.

5. The coil component according to claim 2, wherein
each of the first terminal electrode and the second terminal electrode includes a respective metal plate,
each of the first terminal electrode and the second terminal electrode includes portions extending along the raised portion and the shoulder portions on the mounting surface of each of the first flange portion and the second flange portion, and
in each of the first terminal electrode and the second terminal electrode, the portion extending along the raised portion defines a connection portion with the mounting board, and the portion extending along the shoulder portions defines a connection portion with the wire.

6. The coil component according to claim 5, wherein
rounded surfaces are at both end portions of a top face of the raised portion in the width direction.

7. The coil component according to claim 5, wherein
rounded surfaces are at portions where the raised portion intersects the shoulder portions.

8. The coil component according to claim 5, wherein
both end faces of the raised portion in the width direction includes a gradient.

9. The coil component according to claim 5, wherein
a surface of the raised portion on a side of the inner end surface includes a gradient.

10. The coil component according to claim 3, wherein
at the first flange portion, a gap is between the inner end surface and a first lead-out portion of the wire, the first lead-out portion of the wire being drawn from the winding core portion and reaching the first terminal electrode, and
at the second flange portion, a gap is between the inner end surface and a second lead-out portion of the wire, the second lead-out portion of the wire being drawn from the winding core portion and reaching the second terminal electrode.

11. The coil component according to claim 3, wherein
each of the first terminal electrode and the second terminal electrode includes a respective metal plate,
each of the first terminal electrode and the second terminal electrode includes portions extending along the raised portion and the shoulder portions on the mounting surface of each of the first flange portion and the second flange portion, and
in each of the first terminal electrode and the second terminal electrode, the portion extending along the raised portion defines a connection portion with the mounting board, and the portion extending along the shoulder portions defines a connection portion with the wire.

12. The coil component according to claim 4, wherein
each of the first terminal electrode and the second terminal electrode includes a respective metal plate,
each of the first terminal electrode and the second terminal electrode includes portions extending along the raised portion and the shoulder portions on the mounting surface of each of the first flange portion and the second flange portion, and
in each of the first terminal electrode and the second terminal electrode, the portion extending along the raised portion defines a connection portion with the mounting board, and the portion extending along the shoulder portions defines a connection portion with the wire.

13. The coil component according to claim 10, wherein
each of the first terminal electrode and the second terminal electrode includes a respective metal plate,
each of the first terminal electrode and the second terminal electrode includes portions extending along the raised portion and the shoulder portions on the mounting surface of each of the first flange portion and the second flange portion, and
in each of the first terminal electrode and the second terminal electrode, the portion extending along the raised portion defines a connection portion with the mounting board, and the portion extending along the shoulder portions defines a connection portion with the wire.

14. The coil component according to claim 6, wherein
rounded surfaces are at portions where the raised portion intersects the shoulder portions.

15. The coil component according to claim 11, wherein
rounded surfaces are at portions where the raised portion intersects the shoulder portions.

16. The coil component according to claim 6, wherein
both end faces of the raised portion in the width direction includes a gradient.

17. The coil component according to claim 7, wherein
both end faces of the raised portion in the width direction includes a gradient.

18. The coil component according to claim 6, wherein
a surface of the raised portion on a side of the inner end surface includes a gradient.

19. The coil component according to claim 7, wherein
a surface of the raised portion on a side of the inner end surface includes a gradient.

20. The coil component according to claim 8, wherein
a surface of the raised portion on a side of the inner end surface includes a gradient.
